(19) United States
(12) Patent Application Publication
(10) Pub. No.: US 2002/0097242 A1
(43) Pub. Date: Jul. 25, 2002

(54) Creation and display of surroundings-sensitive content for a large-screen display

(75) Inventors: Brian C. Lowry, Emlenton, PA (US); Evan Wimer, Pittsburgh, PA (US)

Correspondence Address: PEPPER HAMILTON LLP, 50th Floor, One Mellon Center, Pittsburgh, PA, 15219, US

(73) Assignee: Transvision, Inc.

(21) Appl. No.: 10/051,523

(22) Filed: Jan. 18, 2002

Related U.S. Application Data
(60) Provisional application No. 60/263,088, filed on Jan. 19, 2001.

(51) Int. Cl. G06T 11/20

(52) U.S. Cl. 345/440

(57) ABSTRACT

A system for real-time customization of display content for a large screen display (LSD) includes a LSD connected via a communications network to a central processor or server, a plurality of sensors, and a content database connected to the central processor or server. The central processor or server uses one or more software programs for the selection and display of content from the database on the LSD, based on data collected from the plurality of sensors.

In another embodiment, a method for retrieval of sensory data from a LSD including the steps of capturing data from sensory fiber optic strands, processing and packaging the data, electronically transferring packaged data to a central server for comparison to a set of rules for content selection, and updating the content to the LSD.

### CLAIM OF PRIORITY

This application claims priority to U.S. Provisional Patent Application No. 60/263,088, filed Jan. 19, 2001, which is incorporated by reference in its entirety.

### FIELD OF THE INVENTION

This application relates to large screen display systems. More particularly, this invention relates to a large screen display system having the ability to display content that is responsive to external sensory information.

### BACKGROUND OF THE INVENTION

Although the presence of large screen video displays in public venues such as sports stadia has become quite common and even expected, many other possible venues have generally been overlooked. Examples of other appropriate venues for large screen video displays include airports, shopping malls, large retail stores, convention halls, and hotels.

Current public-venue display technologies typically fall into one of two types—large, relatively distant, non-interactive displays (e.g., Sony Jumbotron™ video displays used in many large stadia) or small, touch-screen displays (e.g., information kiosks). Stadium displays can be viewed by large numbers of people, while individual users may approach kiosk displays to acquire customized information to meet their personal needs. A combination of the now mutually exclusive aspects of these two display types would add considerable value to large screen display (LSD) systems.

The real-time acquisition and compilation of data from external sensors in regard to local time, seasonal environment, and traffic levels at a particular venue (to name a few) represents current and accessible technology. In addition, the acquisition of needed information from the World Wide Web and from other types of networked information resources is well established. A means of integrating all of this time-varying data into a process for targeted advertising using a large screen video display, however, is not. There is a need for a way of gathering sensory information to aid in the customized or targeted display of advertising and/or informational content on a large screen video display.

Additionally, if the technology driving large screen video displays were to be enhanced to include interaction with users, the market for equipping new venues could be expanded considerably. Both advertisers and on-site customers would benefit considerably from the capability of interacting directly with and, in turn, modifying the material displayed on large screen video displays. Also, by enabling a large screen video display to track current date and time and to collect time-variable data such as weather changes and changes in the milieu or surroundings, a wide range of advertising promotions customized to such time-varying changes can have a significantly greater impact on the population having access to those large screen displays. Thereby, the development of a process for customizing the content displayed on a large screen display in relation to time-varying changes in the milieu or surroundings in which it is located could add considerable vitality to the out-of-home (“OOH”) advertising market.

In addition, the specific customization of information to targeted groups of viewers, or even to individual viewers, is an overarching concern for advertisers and an area of considerable potential value for the developers of technology. Since audience makeup varies considerably by time and venue, any process controlling this customization must collect and take into account a wide range of time-varying information before such customization will be possible. There is a need for a way to customize content in real-time for input to a large screen video display. In addition, there is a need for a way to enhance the capabilities of a large screen display in relation to the milieu or surroundings in which it is located.

### SUMMARY OF THE INVENTION

A preferred embodiment of the invention comprises a system for selecting and displaying content that includes a large screen display and a computing device that is in communication with the display and which has a processor and a memory. The system also includes a content database containing potential content for the large screen display, a plurality of sensors capable of receiving data indicative of at least one external condition, and a software program. The software program instructs the computing device to apply a set of rules to the data received from the sensors, select display content from the potential content, and deliver the display content to the large screen display.

Optionally, the sensors comprise sensory fiber optic strands that are integral with the display. Such sensory fiber optic strands may be optically connected to a plurality of transducers.

Also optionally, the display includes a plurality of segments, and each of the segments includes a plurality of fiber optic display strands.

In an alternate embodiment of the invention, a method of selecting content for display on a large-screen display apparatus includes the steps of sampling external data using a plurality of sensors to receive sampled data at a predetermined rate, maintaining a database of content in a memory, using a processing device to automatically apply a set of rules to the sampled data, using the processing device to select content from the database based on application of the set of rules to the sampled data, and displaying the content selected from the database on a large screen display apparatus.

Optionally, the sampling step comprises receiving data from a set of sensory fiber optic strands that are integral with the large screen display. Also optionally, the method may include the step of processing the data received from the fiber optic strands into data packets, and/or the step of updating the content database. The method may also include the step of generating an invoice for displaying the content.

### BRIEF DESCRIPTION OF THE DRAWINGS

FIG. 1 illustrates an exemplary system for one-way communication to a large screen display.

FIG. 2 is a flow diagram illustrating a means of content selection for display on a large screen display.

FIG. 3 is a flow diagram illustrating a means for modification of rules and/or content.

FIG. 4 is a flow diagram illustrating a means for receiving new content for display on a large screen display.

FIG. 5 is an exterior view of a system for capture of tactile or proximity sensory data from a large screen display.

FIG. 6 is an interior view of a system for capture of tactile or proximity sensory data from a large screen display.

FIG. 7 is a flow diagram illustrating a means for capture of sensory data from a large screen display.

### DETAILED DESCRIPTION OF PREFERRED EMBODIMENTS OF THE INVENTION

A preferred embodiment of this invention comprises means for the selection, customization, and presentation of milieu- or surroundings-sensitive content for input to a large screen video display. This means also includes ways to collect that information, and modify in real-time the manner in which it is displayed.

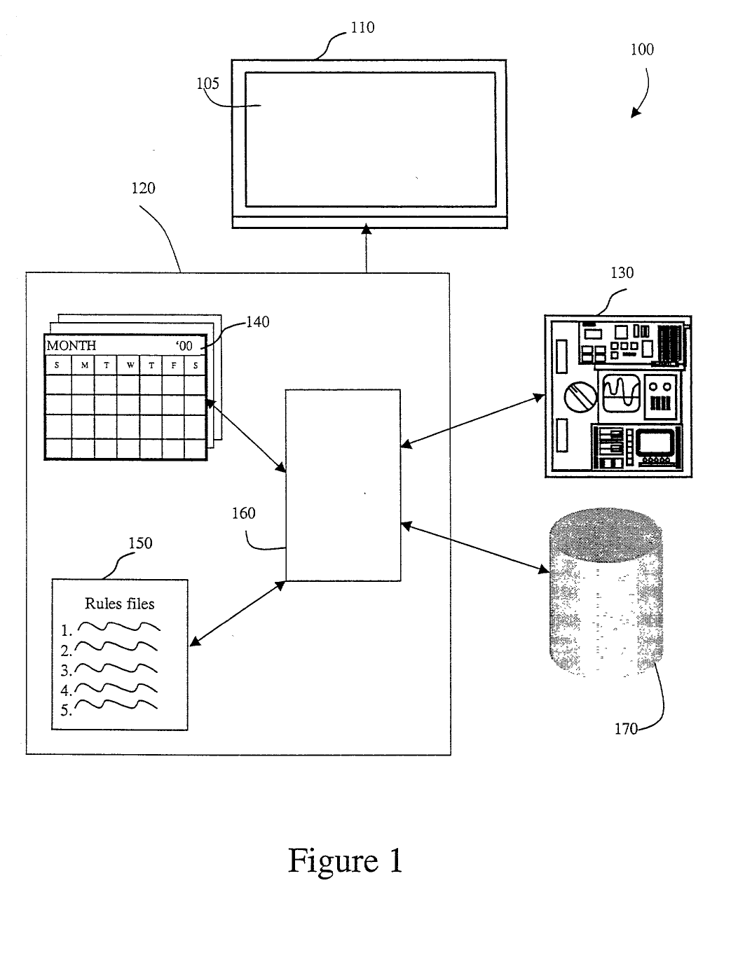

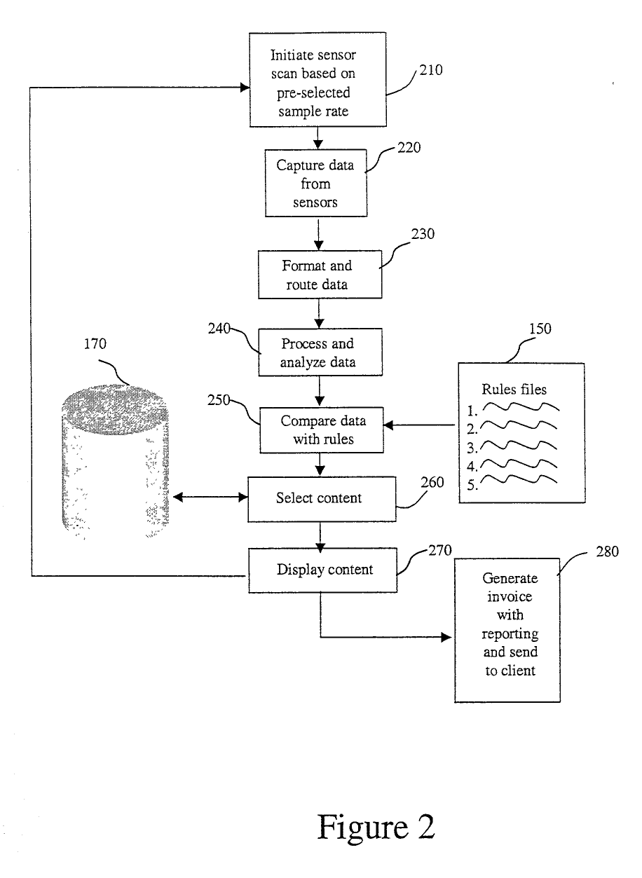

FIG. 1 is a diagram illustrating a system 100 for one-way communication to a large screen display 110 for the purpose of displaying content. System 100 includes a central processor or server 120, a large screen display 110, a display area 105, a plurality of sensors 130, and a content database 170. Housed on the central server are event list files 140, rules files 150 for governing content displayed on a large screen display, and a set of software programs 160, the operation of which is described in FIG. 2. Optionally, instead of an integrated central server 120, system 100 may include a separate processor and computer-readable data storage system, such as read-only memory or random access memory, or even a memory disk or hard drive, and the processor and data storage system are communicative through a communications network.

Central server 120 is electronically connected to large screen display board 110, a sensor or plurality of sensors 130, and content database 170. Event list files 140, rule files 150, and software programs 160 are stored electronically in central server 120. Optionally, the files 140 and 150 and programs 160 are stored on a separate data storage system which is communicative with the central server or processor 120.

In accordance with a preferred embodiment, central server 120 sends display information electronically to large screen display 110. In order to do so for a particular venue, central server 120 electronically retrieves data from plurality of sensors 130, which include devices monitoring sources such as the World Wide Web, local time, weather (temperature, humidity, barometric pressure, precipitation, and/or wind speed and direction and/or other factors), and traffic levels. Central server 120 electronically stores event list files 140 and rule files 150 governing display content on a large screen display 110. Software programs 160 access sensor 130 data, event list files 140, and rule files 150. Software programs 160 then process the data from sensors 130, lists 140, and rules 150, select specific content for display, retrieve selected content from content database 170, and electronically transfer the selected content to large screen display 110.

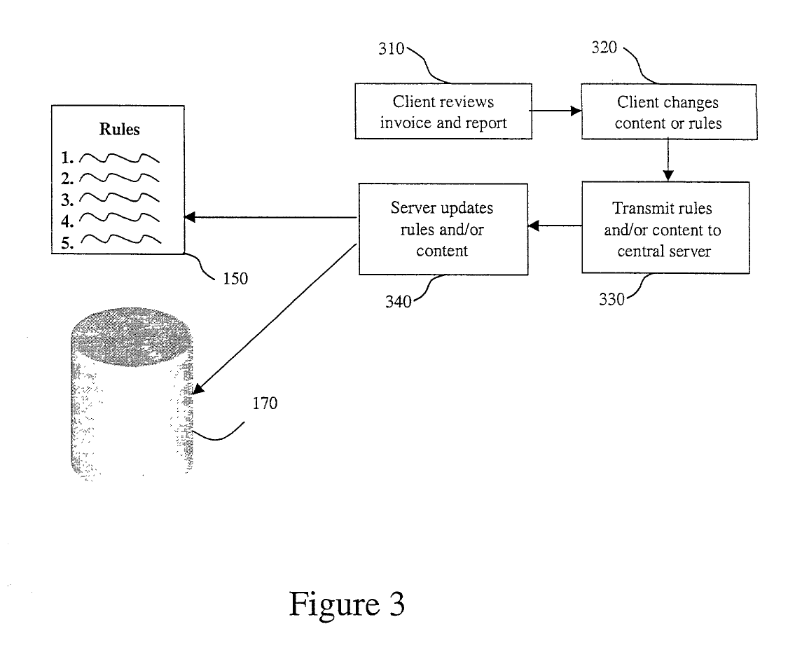

Referring to FIG. 2, a method of content selection for display on a large screen display 110 includes the following steps: In a first step 210, a sensor scan is initiated based on a pre-selected sample rate. In a second step 220, the central server 120 using the sensor array 130 captures a data sample. In a third step 230, that data sample is formatted and routed by software programs 160 as a data packet in accordance with the established format for data samples. In a fourth step, 240 the data packet is processed and analyzed by software programs 160 to determine relevancy with respect to the display environment. An example of such relevancy may include outdoor temperature or data sensitive to the time of the sample (relative to the beginning or end of the business day) compared to data that is less current. Next, in a fifth step 250, the filtered data from step 240 is compared using software programs 160 with rules in rule files 150 (rules may be modified as illustrated and described in FIG. 3). An example of the kind of rules used for comparison may include a rule to display changing weather conditions (such as outdoor temperature, barometric pressure, or precipitation measured by sensors) prior to displaying advertising content. Then in a sixth step 260, material from content database 170 is selected by software programs 160 for display. Next, in a seventh step 270, the selected content is displayed on a large screen display 110. Finally, in an eighth step 280, an invoice for the cost of the content displayed is generated by software programs 160 and sent electronically to the client bearing ownership of that content.

Referring to FIG. 3, a method for modification of rules and/or content includes the following steps: In a first step 310, the client reviews an invoice and report created as shown and described in FIG. 2, concerning content previously displayed. Then, in a second step 320, the client changes the content, and/or rules governing that content. An example of a change in content is a rewording or reworking of an advertisement, and an example of a change in the rules governing that content is a request for more frequent displays of an already existing advertisement. Next, in a third step 330, the client electronically transmits the requested changes to the central server 120 for the large screen display 110. This electronic transmission is submitted using any one of a wide array of communications devices (not shown), including but not limited to a personal computer (“PC”) connected to the Internet or other communications medium, a wireless digital or cellular telephone, preferably with wireless web capabilities, a personal digital assistant (“PDA”) with similar network connectivity, an onboard computing system having communications capabilities, or a wearable Internet appliance (“WIA”). In a fourth step 340, the central server 120 for the large screen display 110 receives the client's modifications and updates rule files 150 and/or content database 170, and all changes are subsequently included in the method of content selection for display on a large screen display 110 (as shown and described in FIG. 2).

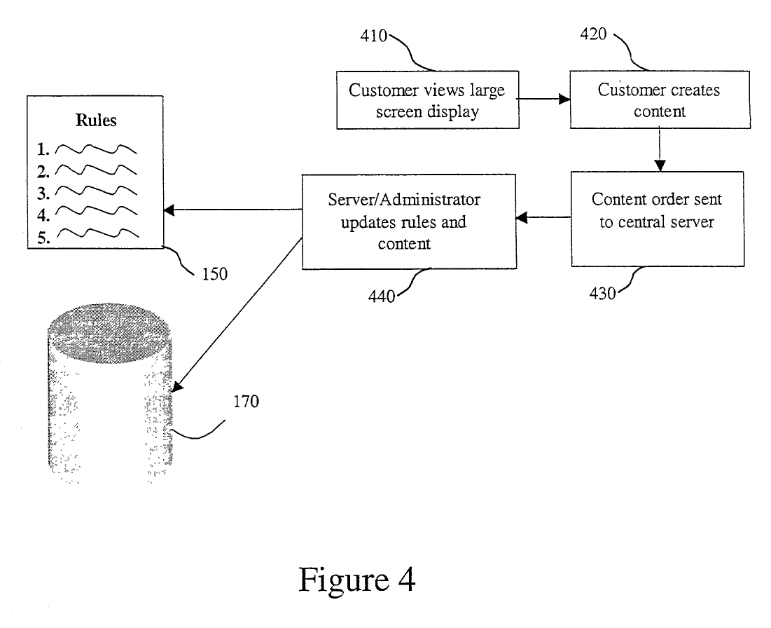

Referring to FIG. 4, a method for receiving new content for display on a large screen display 110 includes the following steps: In a first step 410, a new customer (not shown) views a large screen display 110 upon which content is displayed. One example of a new customer would be an advertiser looking to post content promoting certain goods and/or services on the large screen display 110. In a second step 420, the customer creates content to be displayed. Next, in a third step 430, an order detailing that new content is electronically sent to the central server 120 for the large screen display 110 (e.g., using the posted web address for the central server 120). The receipt of this order can be automatically accepted by the central server 120 for the large screen display 110 or processed by a system administrator. In a fourth step 440, the order is processed (either automatically by the central server 120 or with the administrator's review), leading to the creation of new rules files 150 or updates of existing rules files 150 and updates of the content database 170, and all changes are subsequently included in the method of content selection for display on a large screen display (as shown and described in FIG. 2).

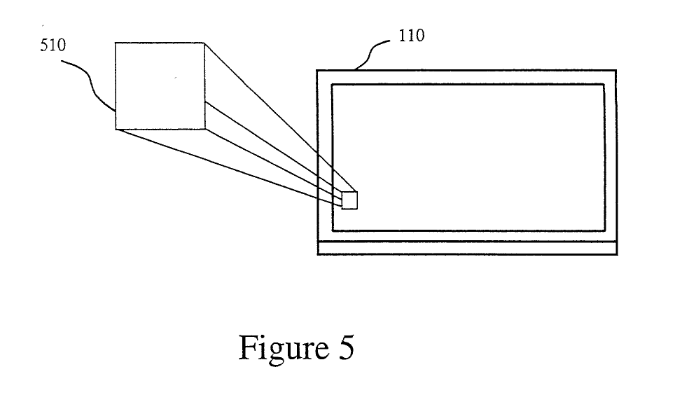

FIG. 5 illustrates an exterior view of a system for retrieval of sensory data from a large screen display. FIG. 5 includes large screen display 110, and a segment of the display 510.

Segment of display 510 is a representative sample of large screen display 110. Segment of display 510 constitutes a portion of large screen display 110. Examples of large screen displays including display segments are shown and described in U.S. Pat. No. 6,304,703 entitled “Tiled Fiber Optic Display Apparatus,” and U.S. patent application Ser. No. 09/569,811, entitled “Micro-Display Driven Tiled Electro-Optic Display Apparatus,” filed May 12, 2000, each of which is incorporated herein by reference in its entirety.

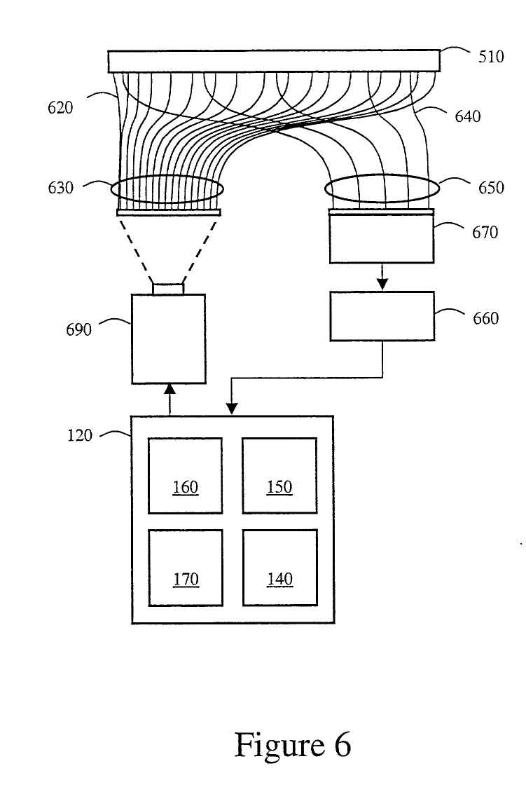

In operation, the entire display surface of large screen display 110 or any segment 510 can receive sensory data from either the direct touch or close proximity of a viewer. The underlying operation of a segment of display 510 is addressed in FIG. 6, and should be interpreted as a description of the entire surface of large screen display 110.

FIG. 6 provides an interior side view of a system for retrieval of sensory (tactile or proximity) data from a large screen display 110. FIG. 6 includes a side view of display segment 510 (a portion of large screen display surface 105), a display fiber optics bundle 630 comprised of a plurality of individual display fiber optic strands 620, and a sensor fiber optics bundle 650 comprised of a plurality of individual sensor fiber optic strands 640. Sensor fiber optics bundle 650 terminates at and optically connects to one or a plurality of opto-electric transducers 670 which generate electrical signals in proportion to the intensity of light illuminating the individual fiber strands 640 which comprise the sensor fiber optic bundle 650. Opto-electric transducer 670 is electrically connected to data acquisition card 660, which is electrically connected to the central server 120 for the large screen display 110. Central server 120 includes event list files 140, rules files 150, software programs 160, and content database 170 electronically stored within it. Display fiber optics bundle 630 terminates behind the large screen display in the proximity of video/data projector 690, which projects images onto the end of display fiber optics bundle 630, these images constituting the display content which is viewed on the large screen display 110. Video/data projector 690 is electrically connected to and controlled by central server 120 for the large screen display system 100. In operation, a user touches or comes in close proximity to the large screen display board, resulting in a change (generally a decrease) in illumination of sensor fiber optic strands 640 comprising sensor fiber optics bundle 650 with a subsequent change in electrical output of opto-electric transducer 670, which change, in turn, is captured and processed, by data acquisition card 660, and then transferred to central server 120. This new data is then used to update the rules governing display of content. Display content can then be updated, which content is then sent electronically to video/data projector 690. Display fiber optics bundle 630 receives the projected images from video/data projector 690; individual display optic strands 620 then display the content on large screen display 110.

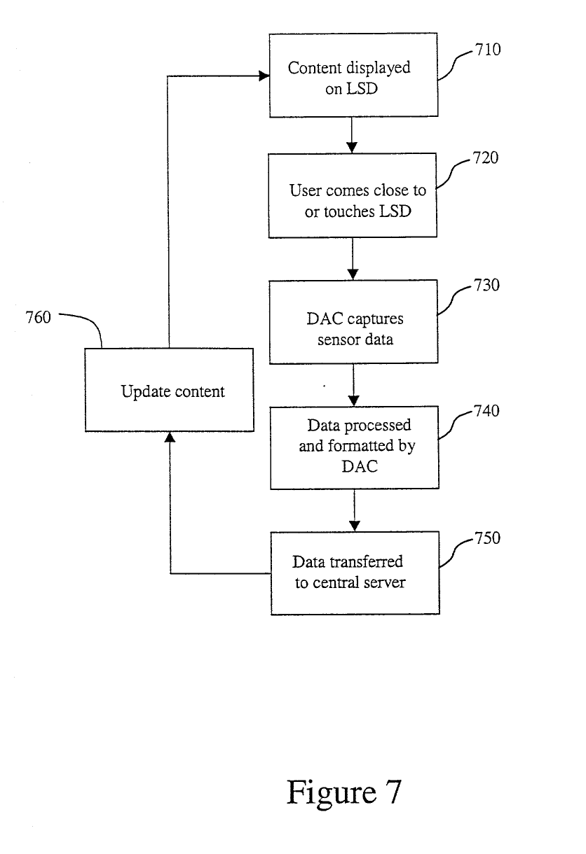

Referring to FIG. 7, a method for capture of sensory data from a large screen display includes the following steps. In a first step 710, content is displayed on a large screen display 110. In a second step 720, a viewer comes into proximity to or touches a segment 510 of the large screen display 110. In a third step 730, sensor data is captured by the data acquisition card (DAC) 660 from sensors 130 integrated into the display area 105 of the large screen display 110. Then in a fourth step 740, data is processed by the DAC 660 and converted to the format required by the software program 160 running on the central server 120. In a fifth step 750, this formatted data is transferred to the central server 120. Finally, in a sixth step 760 display content is updated based upon the new data sent to the central server 120, and the new or revised content is transferred to the large screen display 110 for display, as in step 710. Exemplary sensors may include photosensors, temperature transducers, relative humidity sensors, barometric pressure detectors, wind speed detectors, clocks, counters such as pressure sensitive traffic counters, and other types of sensors such as proximity or touch-sensitive sensors.

One benefit of this invention is that it discloses a means for real-time customization of content for display on a large screen display. A second benefit of this invention is that it discloses a means for automatically receiving display content updates from and sending subsequent invoices and reports to recognized clients providing display content for a large screen display.

It is to be understood that the invention is not limited in its application to the details of construction and to the arrangements of the components set forth herein or illustrated in the drawings. Other embodiments of the invention may be comprehended and the invention may be put into practice and carried out in various ways. Also, it is to be understood that the phraseology and terminology employed herein, as well as the abstract included below, are for the purpose of description and should not be regarded as limiting.

As such, those skilled in the art will appreciate that the concept upon which this application is based may readily be utilized as a basis for the design of other structures, methods and systems for carrying out the several purposes of this invention. Further, since numerous modifications and variations will readily occur to those skilled in the art, the invention is not limited to the exact construction and operation illustrated and described, and accordingly, all appropriate modifications and equivalents fall within the scope of the invention.

The invention claimed is:

1. A system for selecting and displaying content, comprising:
a large screen display;
a computing device in communication with the display, the computing device having a processor and a memory;
a content database containing potential content for the large screen display;
a plurality of sensors capable of receiving data indicative of at least one external condition; and
a software program providing instructions for instructing the computing device to:
apply a set of rules to the data received from the sensors;
select display content from the potential content; and
deliver the display content to the large screen display.

2. The system of claim 1 wherein the sensors comprise sensory fiber optic strands that are integral with the display.

3. The system of claim 2 wherein the sensory fiber optic strands are optically connected to a plurality of transducers.

4. The system of claim 1 wherein the large screen display includes a plurality of segments, each segment including a plurality of fiber optic display strands.

5. A system for selecting and displaying content, comprising:
a large screen display, the display including a plurality of segments, each segment including a plurality of fiber optic display strands;
a computing device in communication with the display, the computing device having a processor and a memory;
a content database, the content database containing potential content for the large screen display;
a plurality of sensors capable of receiving data indicative of at least one external condition, the sensors comprising sets of sensory fiber optic strands that are integral with the display and transducers that are in optical communication with the strands; and
a software program providing instructions for instructing the computing device to:
apply a set of rules to the data received from the sensors,
select display content from the potential content; and
deliver the display content to the large screen display.

6. A method of selecting content for display on a large-screen display apparatus, comprising:
sampling, at a predetermined rate, external data using a plurality of sensors to receive sampled data;
maintaining, in a memory, a database of content;
using a processing device to automatically apply a set of rules to the sampled data;
using the processing device to select content from the database based on application of the set of rules to the sampled data; and
displaying the content selected from the database on a large screen display apparatus.

7. The method of claim 6 wherein the sampling step comprises receiving data from a set of sensory fiber optic strands that are integral with the large screen display.

8. The method of claim 7 further comprising the step of processing the data received from the fiber optic strands into data packets.

9. The method of claim 6 further comprising the step of updating the content database.

10. The method of claim 6 further comprising the step of generating an invoice for displaying the content.
